(19) United States
(12) Patent Application Publication
(10) Pub. No.: US 2014/0083222 A1
(43) Pub. Date: Mar. 27, 2014

(54) GEAR ASSEMBLY WITH THERMAL EXPANSION MATCHING

(71) Applicant: Pinnacle Engines, Inc., San Carlos, CA (US)

(72) Inventor: James M. Cleeves, Redwood City, CA (US)

(73) Assignee: Pinnacle Engines, Inc., San Carlos, CA (US)

(21) Appl. No.: 14/033,357

(22) Filed: Sep. 20, 2013

Related U.S. Application Data
(60) Provisional application No. 61/704,418, filed on Sep. 21, 2012.

(51) Int. Cl. F16H 57/12; F16H 1/06

(52) U.S. Cl. CPC F16H 57/12; F16H 1/06
USPC 74/421 R; 74/434

(57) ABSTRACT

A gear or gear assembly, for example for use in a gear train or other drive system relating to an engine such as an internal combustion engine, can be matched to the thermal expansion other engine components, such as for example a support structure for gear shafts on which gears of the gear train rotate, while maintaining structural strength in the teeth and other contact surfaces of the gear.

### REFERENCE TO PRIORITY DOCUMENT

This application claims the benefit of priority under 35 U.S.C. §119(e) of U.S. provisional patent application Ser. No. 61/704,418 filed Sep. 21, 2012. Priority of the filing date is hereby claimed. This application is also related to Patent Cooperation Treaty Application No. PCT/US2013/060839, filed on Sep. 20, 2013. The full disclosure of each the aforementioned applications is incorporated herein by reference.

### FIELD

The subject matter described herein relates to gears and gear assemblies, for example for use in a gear train or other drive system relating to an engine such as an internal combustion engine.

### BACKGROUND

Thermal expansion is the tendency of matter to change in volume in response to a change in temperature. While a solid can generally expand volumetrically (e.g. in all directions), in many instances expansion in one dimension is of greater importance. Accordingly, a linear coefficient of expansion can be used to estimate the magnitude of expansion along a given axis of the solid, for example using the following equation:

$${α}_{L} = \frac{1}{L} \frac{d L}{d T} \qquad ( 1 )$$

In equation 1, α_{L}, is the linear coefficient of thermal expansion, L is the length along the axis of expansion, and dL/dT is the rate of change in that linear dimension per unit change in temperature. Equation 1 can be rearranged algebraically using the assumption that the linear coefficient of thermal expansion does not vary dramatically over the range of temperature variability to solve for the change in the linear dimension, ΔL:

ΔL=Lα_{L}ΔT (2)

As shown by equation 2, if the linear coefficient of thermal expansion (α_{L}) is approximately constant over the temperature range, the change in the linear dimension is directly proportional to the length of the object (L), the change in temperature (ΔT), and the linear coefficient of thermal expansion (α_{L}).

### SUMMARY

In one aspect of the current subject matter, a gear assembly includes a gear core and a ring gear. The gear core includes (e.g. is formed of, made from, etc.) a first material having a first coefficient of thermal expansion, which is either a) approximately equal to a gear train support coefficient of thermal expansion of a gear train support structure onto which the gear assembly is configured to be mounted or b) at least approximately proportional to the gear train support coefficient of thermal expansion according to a ratio of a first operation temperature of the gear assembly divided by a second operation temperature of the gear train support structure. The ring gear is disposed along a perimeter of the gear core and includes (e.g. is formed of, made from, etc.) a second material having a second coefficient of thermal expansion. The second coefficient of thermal expansion is smaller than the first coefficient of thermal expansion.

In another interrelated aspect, a method includes transmitting rotational force along a gear train that includes two gears mounted on rotating shafts secured at a relative separation distance by a support structure. The two gears include intermeshing gear teeth. The method further includes causing the support structure and gear train to experience second temperatures during operation of an apparatus comprising the support structure, where the second temperature is at least approximately 75° C. greater than a first temperature experienced by the support structure during non-operation of the apparatus comprising the support structure. A tolerance distance that is substantially equivalent at both the first temperature and the second temperature is maintained between the intermeshing gear teeth of the two gears. Optionally, at least one gear of the two gears can include a gear assembly. The gear assembly can include a gear core and a ring gear, where the gear core includes a first material having a first coefficient of thermal expansion that is a) approximately equal to a gear train support coefficient of thermal expansion of the support structure or b) at least approximately proportional to the gear train support coefficient of thermal expansion according to a ratio of a first operation temperature of the gear assembly divided by a second operation temperature of the gear train support structure. The ring gear can be disposed along a perimeter of the gear core and can include a second material having a second coefficient of thermal expansion that is smaller than the first coefficient of thermal expansion.

Another interrelated aspect includes a method for assembling a gear assembly for use as part of a gear train that includes two gears mounted on rotating shafts secured at a relative separation distance by a gear train support structure. The two gears includes intermeshing gear teeth. The method includes heating a ring gear to at least an assembly temperature in a range between an operating temperature of an apparatus that includes the gear train and the gear train support structure and a non-operating temperature of the apparatus. The method further includes joining the ring gear to a gear core such that the ring gear is disposed along a perimeter of the gear core to form the gear assembly. The gear core includes a first material having a first coefficient of thermal expansion. The first coefficient of thermal expansion is approximately equal to a gear train support coefficient of thermal expansion of the gear train support structure. The ring gear includes a second material having a second coefficient of thermal expansion. The second coefficient of thermal expansion is smaller than the first coefficient of thermal expansion. The assembly temperature range can optionally be approximately 40° C. to 100° C. The joining can optionally include pressing the ring gear over the ring core or can optionally include casting the gear core by providing the second material in a molten form inside of the ring gear. For the casting, the method can optionally further include allowing the gear assembly to cool to the non-operating temperature such that the gear core transmits a contracting force on the ring gear at the non-operating temperature and an expansion force on the ring gear at the operating temperature. At least the contracting force can optionally be transmitted from the gear core to the ring gear at least in part via a tensioning feature on the ring gear that is interlocked with a mating feature on the gear core.

In optional variations, one or more additional features can be included in any feasible combination. Such additional features can include, but are not limited to, those discussed here. For example, the gear train support structure can include an engine block of an internal combustion engine. The first material can include one or more of aluminum, magnesium, brass, silicone or plastic, and the second material can include steel. The ring gear can include tooth features disposed along an outer periphery of the ring gear for meshing with one or more other gears or gear assemblies. A hub of the gear assembly can include the second material. A ratio of the first coefficient of thermal expansion to the second coefficient of thermal expansion can be within a range of approximately 1.5 to 2. The first coefficient of thermal expansion can be within a range of approximately 20×10⁻⁶ m·m⁻¹·K⁻¹ to 25×10⁻⁶ m·m⁻¹·K⁻¹ at 25° C., and the second coefficient of thermal expansion can be within a range of approximately 10×10⁻⁶ m·m⁻¹·K⁻¹ to 15×10⁻⁶ m·m⁻¹·K⁻¹ at 25° C. The ring gear can include a tensioning feature that interlocks with a mating feature of the gear core. The tensioning feature interlocked with the mating feature can facilitate transmission of at least contraction forces exerted by the gear core to the ring gear. The tensioning feature can have a triangular or trapezoidal shape, such that an apex of the triangular or trapezoidal shape that is narrower than a base of the triangular or trapezoidal shape is directed away from a center axis of the gear core. The support structure can include an engine block of an internal combustion engine. The first material comprises one or more of an aluminum, magnesium, brass, silicone or plastic.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram of an opposed piston engine that includes a gear train linking two crankshafts.

FIG. 2 is a diagram of a gear assembly showing features consistent with implementations of the current subject matter.

FIG. 3 is a diagram of another gear assembly showing features consistent with implementations of the current subject matter.

FIG. 4 is a chart showing an example of stresses exerted on a ring gear as a function of temperature.

FIG. 5 shows a first process flow chart illustrating features of a method consistent with implementations of the current subject matter.

FIG. 6 shows a second process flow chart illustrating features of a method consistent with implementations of the current subject matter.

When practical, similar reference numbers denote similar structures, features, or elements.

### DETAILED DESCRIPTION

Materials used in engine blocks and other components of internal combustion engines can be selected for a variety of reasons, including but not limited to weight, structural strength, etc. Use of materials with differing coefficients of thermal expansion in an engine can lead to inconsistent behavior of various components when the engine is at its operating temperature. The effects of differing thermal expansivity of two objects made of differing materials increase with the size of those two objects, the relative difference in the linear coefficients of thermal expansion (α_{L}) of the two materials, and the change in temperature. As such, an engine that uses large gears made of a different material than the engine block or other support structure that retains the axes about which those gears rotate can experience a substantially variable clearance difference between the gears between cold and hot operation.

As an example of the above-discussed issues that can arise through the use of materials with markedly different thermal expansion properties, an engine such as those described in international patent publication no. WO/2007/121086 (“Internal Combustion Engine”) can advantageously have an engine block made of aluminum. The gear train in such an engine, which uses an opposed piston configuration, can be quite large in order to transfer power from two parallel crankshafts to a single drive shaft. Two or more gears can span the distance between the two crankshafts, which can be at least several tens of centimeters. Other types of engines besides the example provided can also benefit from the current subject matter. The engine block of a low displacement engine can advantageously be formed of aluminum for weight reduction and thermal conductivity. However, the gears of such an engine are usually formed of steel rather than aluminum because the relatively low hardness of the aluminum can lead to high wear of the contact surfaces of such gears. Steel can be used for improved resistance to both gear tooth bending loads and gear tooth contact stresses.

Aluminum has a linear coefficient of thermal expansion (α_{L}) at 25° C. of approximately 22.2×10⁻⁶ m·m⁻¹·K⁻¹, while steel has a linear coefficient of thermal expansion (α_{L}) at 25° C. of approximately 13.0×10⁻⁶ m·m⁻¹·K⁻¹. Accordingly, an aluminum engine block can generally expand to a much greater degree than steel gears exposed to temperatures comparable to those experienced by the engine block. If either or both of the gear size and the total length of the gear train is small, this expansion can have a relatively small effect. However, if the gears are large, if the gear train spans a larger distance, or both, problems can occur, for example if a first material from which the engine block (or other support structure) is formed has a substantially greater coefficient of thermal expansion than does a second material from which the gears of the gear train are formed. With reference to equation 2 above, for two objects of original length L constructed of a first material and a second material respectively having the linear coefficients of thermal expansion α_{L,1} and α_{L,2}, the excess length increase ΔL_{E} of the first object relative to the second object for a same change in temperature (ΔT) can be represented as follows:

ΔL_{E}=ΔL₁−ΔL₂=L·ΔT(α_{L,1}−α_{L,2}) (3)

Accordingly, a first object made of aluminum and a second object made of steel that are each 0.5 m long at 25° C. would differ in length by about 0.0014 m (1.4 mm) at 325° C. and by about 0.0008 m (0.8 mm) at 200° C. assuming that the linear coefficients of thermal expansion given above are relatively constant over the temperature range of interest.

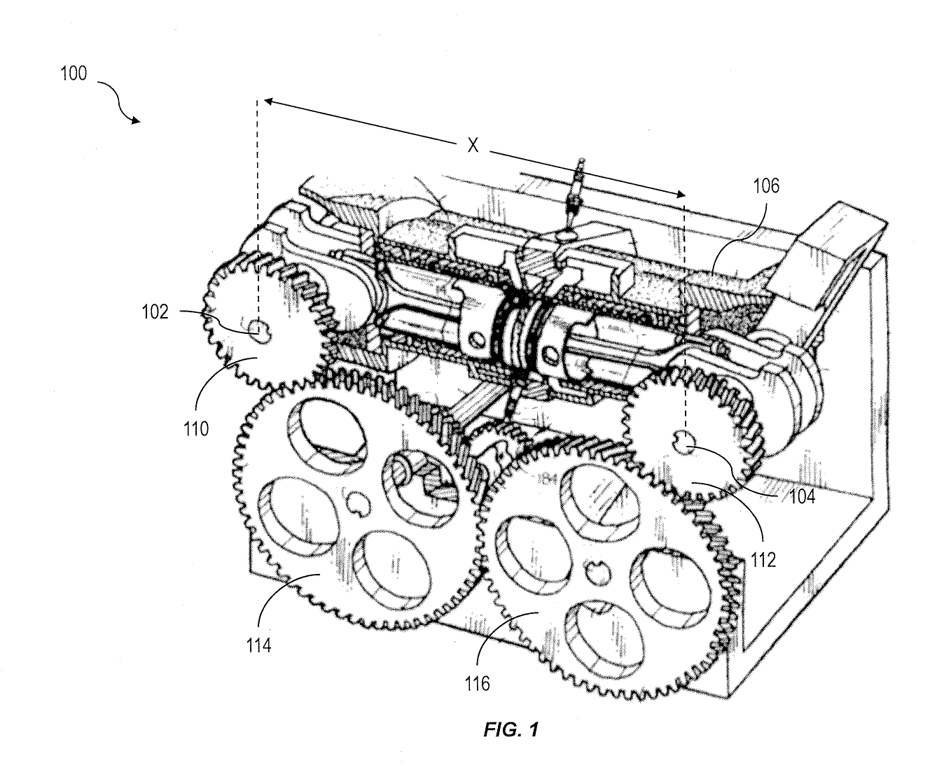

This effect can be further understood by reference to FIG. 1, which shows an example of an engine 100 in which a first crankshaft 102 and a second crankshaft 104 are secured within an engine block 106. The two crankshafts 102, 104 are separated by a distance X. Two or more gears (in the example of FIG. 1, four gears 110, 112, 114, 116) can form a gear train linking the crankshafts 102, 104. In an example (not shown in FIG. 1) in which a linear gear train links the two crankshafts, the gear train can span a distance X. In the example of FIG. 1, however, the two crankshaft gears 110, 112 are not collinear with the two linking gears 114, 116, so the total length of the gear train is greater than X. Assuming that the gear train is as short as possible (e.g. a length X), the potential additional expansion spacing between the crankshafts relative to the expansion of the gears along the length of the gear train, the minimum potential additional spacing between the gears over a 150° C. change in temperature can be found by substituting X for L in equation 3. As discussed above, this can be on the order of a millimeter or more for gears made of steel, an engine block made of aluminum, and a relatively small crankshaft separation distance X. As X increases, for example because of increased piston travel lengths in a larger engine, use of a non-linear gear train as shown in FIG. 1, etc., the additional spacing introduced into the gear train can become even larger. Additional spacing between gears of even millimeter scales can introduce a large tolerance or amount of “play” between the gears, for example during hot operation if the gears are sized to mesh properly at lower temperatures, which can lead to noise, wear, friction issues, and other potential problems due to the poor fit between the gear teeth of mating gears at engine operating temperatures.

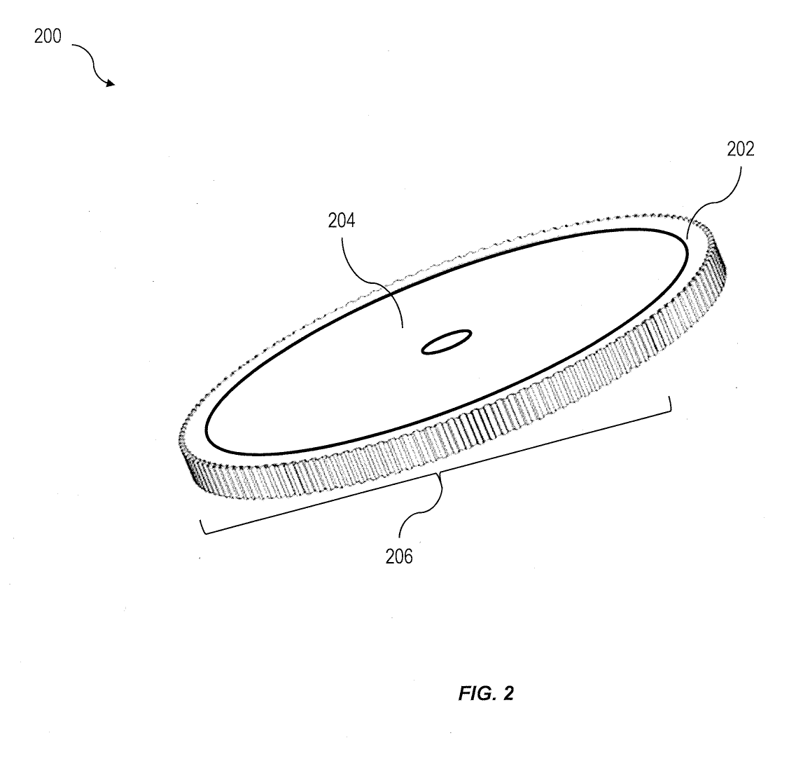

Implementations of the current subject matter can provide gear designs that include matching of thermal expansivity between a support structure, such as for example an engine block, and one or more gears whose axes are secured by the supporting structure. With reference to FIG. 2, an approach including one or more of such beneficial features can be realized in a gear assembly 200 that includes a ring gear 202 of a first, high strength material attached to a gear core 204 of a second, thermal expansion matched material that has expansion properties consistent with the support structure. In one example, the ring gear 202 can be formed of steel and the gear core 204 can be formed of aluminum.

In one example, a gear assembly 200 can include a ring gear 202 pressed over a gear core 204. The ring gear 202 can be formed of a first, high strength material, such as for example steel, while the gear core 204 can be formed of a second material (in some examples aluminum) that is thermal expansion matched to other components of an engine, such as for example an engine block 106 or other structure that supports and maintains a distance between an axis of rotation (such as for example a crankshaft 102, 104) about which the gear assembly 200 rotates and an axis of rotation about which another gear or gear assembly rotates. The ring gear 202 can include teeth 206 around its outer periphery for meshing with one or more other gears or gear assemblies. Use of a thermally expanding material such as aluminum for the gear core 204 of a gear assembly 200 with a ring gear 202 of a tougher material such as steel forming the perimeter of the gear assembly 200 and being structurally integrated to the gear core 204 can produce a gear assembly 200 that behaves structurally like the first material of the ring gear 202 and thermally like the second material of the gear core 204.

Consistent with one or more implementations of the current subject matter, a ratio of the first coefficient of thermal expansion to the second coefficient of thermal expansion can optionally be within a range of approximately 1.5 to 2. The first coefficient of thermal expansion can optionally be within a range of approximately 20×10⁻⁶ m·m⁻¹·K⁻¹ to 25×10⁻⁶ m·m⁻¹·K⁻¹ at 25° C., or within a range of approximately 22×10⁻⁶ m·m⁻¹·K⁻¹ to 23×10⁻⁶ m·m⁻¹·K⁻¹ at 25° C. The second coefficient of thermal expansion can optionally be within a range of approximately 10×10⁻⁶ m·m⁻¹·K⁻¹ to 15×10⁻⁶ m·m⁻¹K⁻¹ at 25° C. or within a range of approximately 12.5×10⁻⁶ m·m⁻¹·K⁻¹ to 13.5×10⁻⁶ m·m⁻¹·K⁻¹at 25° C.

A gear assembly 200 having one or more features consistent with implementations of the current subject matter can be formed using one or more methods including those described below and others including similar or comparable features.

Some conventional flywheels for use in the automotive industry can include a steel or cast iron inner disk with a steel ring gear fitted to the outside of the inner disk. This approach to flywheel construction has generally been used to allow easy repair of the gear teeth on the steel ring gear, for example if a problem arises with engagement of the starter mechanism with the teeth of the ring gear. The use of a material with a substantially different coefficient of thermal expansion was not contemplated and generally not necessary as such flywheels are generally not exposed to the large range between operating and non-operating temperatures that a gear train experiences in an engine, such as for example an engine 100 as shown in FIG. 1.

Other conventional examples of flywheels that have included a gear core of one material and a ring gear of another have been designed with the intent to reduce weight. Such flywheels and gears have generally been formed by thermal expansion (e.g. by heating) of the ring gear, fitting of the expanded ring gear over the core disc, cooling to cause the ring gear to become tightly attached to the exterior of the core disc. However, such an approach can be subject to difficulties if the assembly is exposed to operating temperatures substantially higher than the assembly temperature. For example, the ring gear can experience a high degree of strain due to greater expansion of the core disc if the fly wheel were exposed to a large temperature increase relative to the assembly temperature such as is typical of gears in a gear train of an engine.

Consistent with some implementations of the current subject matter, a gear assembly 200 can be formed by a process that includes pressing a ring gear 202 of a first material over a gear core 204. Some of the added stresses that can occur at operating temperatures much higher than the temperature at which the gear assembly 200 is constructed can be mitigated by raising the construction temperature to closer to the engine operating temperature. For example, rather than constructing a gear assembly at approximately 25° C. for an operating temperature of approximately 150° C., the construction temperature can be raised to approximately 100° C. or some other temperature higher than a resting temperature of the engine.

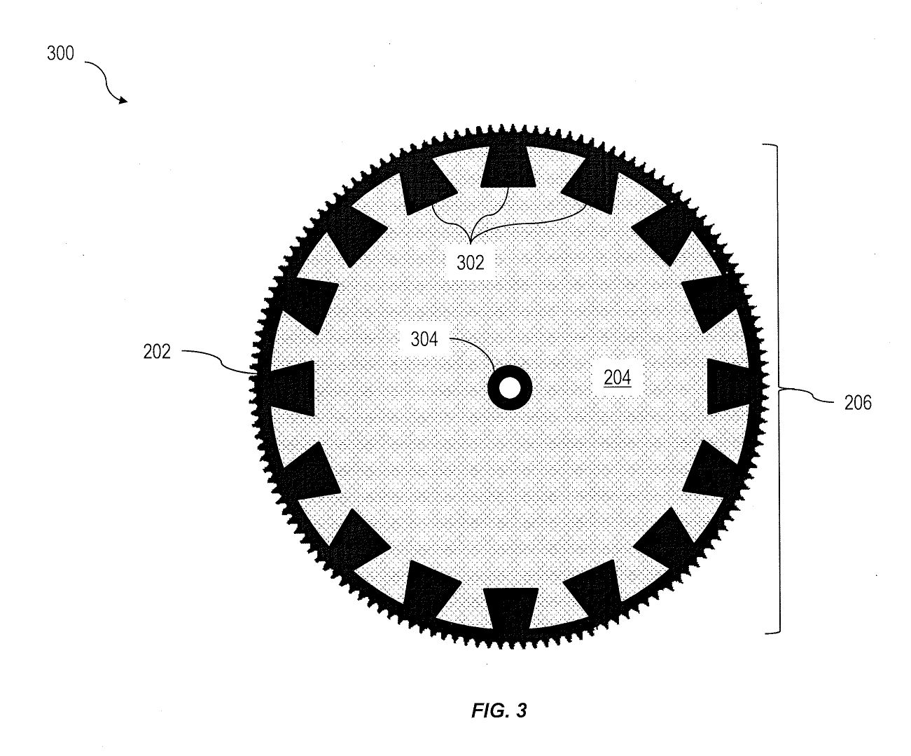

In an alternative approach consistent with implementations of the current subject matter, the gear core 204 can be cast by providing a molten form of the second material inside of a preformed ring gear 202 and allowing the assembly to cool such that the molten second material hardens to form the gear core 204. With reference to FIG. 3, which shows another example of a gear assembly 300, the ring gear 202 can optionally include one or more tensioning features 302 that can interlock with the gear core 204, for example as it cools from the molten phase. This interlocking can apply tension to the ring gear 202 as the gear assembly 300 cools such that the first material of the ring gear 202 is under compression when cool (for example at an engine resting temperature). As the engine and the gear assembly heat up during initial operation, the expansion of the gear core 204 causes the ring gear 202 to experience approximately zero tension or expansion stress at an intermediate temperature between the resting temperature and the peak operating temperature. When the engine is very hot, the ring gear 202 can experience some expansive stress as the gear core 204 further expands.

The amount of tensioning stress experienced by the ring gear 202 at low temperature and the amount of expansive stress experienced at peak engine temperatures can be dependent on an amount of stress relaxation the second material experiences after the casting process. The second material and the first material are at or near the same temperature as the second material transitions from the liquid to the solid phase. Further cooling when both the gear core 204 and the ring gear 202 are in the solid phase applies an inwardly directed tensioning force on the ring gear 202 applied through the tensioning features 302 of the ring gear 202. As both the second material of the gear core 204 and the first material of the ring gear 202 cool further, the second material of the gear core 204 (which has a larger coefficient of thermal expansion than does the first material) shrinks more than does the first material of the ring gear 202, which causes the ring gear 202 to be put into compression. The teeth 206 on the ring gear 202 can be cut before or after casting of the gear core 204. In a further implementation, the gear core 204 can include a hub 304 as shown in FIG. 3. The hub 304 can optionally be formed of the first material (e.g. steel). The hub 304 can be included as a preformed item when the gear core 204 is cast with the second material in liquid form. This approach can allow for higher torque to be transmitted by the gear assembly 300, for example when using an interference fit between the gear assembly 300 and a shaft (e.g. a crankshaft 102, 104). An interference fit refers to a fastening between the ring gear 202 and the gear core achieved by friction after the parts are pushed together, rather than by any other means of fastening.

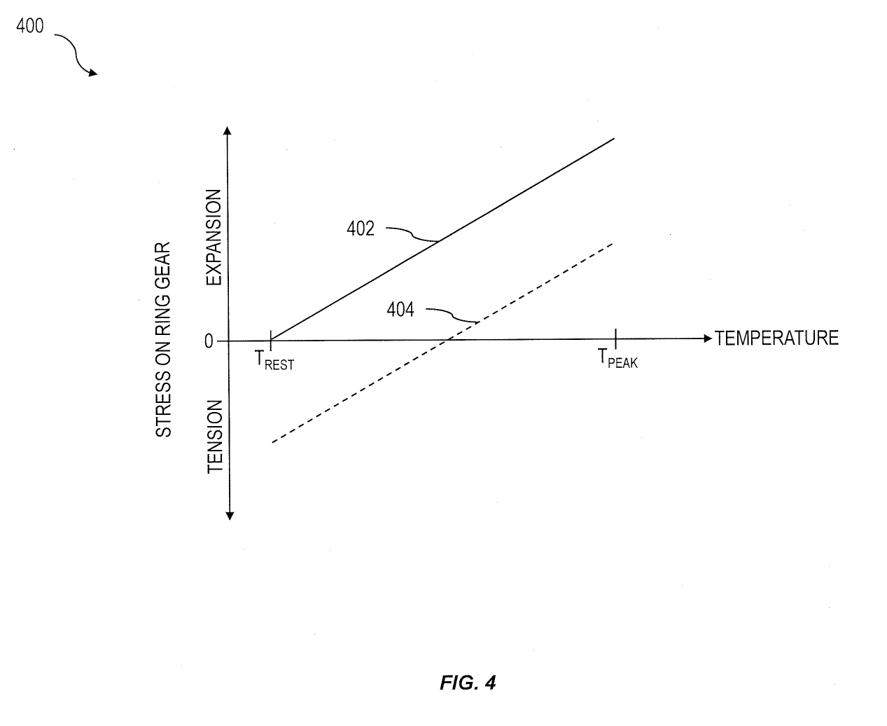

By allowing the ring gear 202 to experience both tensioning stress and expansive stress rather than solely expansive stress as the engine heats up from its resting temperature, the magnitude of the stress can be reduced. FIG. 4 shows a chart 400 illustrating an example of a difference between total stress experienced by a ring gear 202 as part of a ring assembly constructed at an engine resting temperature (shown by the solid line 402) and a ring gear 202 as part of a ring assembly in which the gear core 204 and the ring gear 202 are joined as solids at a temperature between the resting temperature, T_{REST}, and a peak operating temperature, T_{PEAK} (shown by the dashed line 404). The first, ring gear material and the second, gear core material are the same in the two examples. The relationships in FIG. 4 are based on assuming a constant coefficient of thermal expansion for each of the first and second materials over the temperature range from resting temperature to peak operating temperature. As shown in FIG. 4, the line 404 for a gear assembly having features consistent with implementations of the current subject matter experiences a smaller maximum amount of stress over the range of operating temperatures (T_{REST} to T_{PEAK}). The range of operating temperatures can optionally be from a temperature low enough to account for winter weather (e.g. −40° C.) to a peak operating temperature, which can depend on the engine, type of fuel burned, richness of combustion mixture (e.g. richness or leanness relative to a stoichiometric air-fuel ratio), etc.

Not all of the gears in a gear train need be constructed in a manner consistent with implementations of the current subject matter in order to realize one or more of the advantages. For example, with reference to FIG. 1, a gear assembly 200, 300 such as is described herein can replace one of the larger gears 114, 116 while the smaller gears 110, 112 can be solid cast from a first material (e.g. steel).

Gear assemblies consistent with implementations of the current subject matter can run quieter than conventional gears. For example, the fit between adjacent gears (or gear assemblies) can be held near constant with a change in temperature such that the tolerance between gears (or gear assemblies) can be minimized as installed. Additionally, if a second material, such as for example aluminum) is chosen with a lower modulus the intensity of sound energy transmission can be reduced. Use of materials other than aluminum for the gear core 204 are also within the scope of the current subject matter as discussed above. If plastic is used as the gear core 204, even more of the sound energy generated can be dampened.

The one or more tensioning features 302 discussed above can include a variety of shapes and configurations to facilitate transmission of expansion and contraction forces exerted by the gear core 204 to the ring gear 202. For example, the one or more tensioning features 302 can be shaped similarly to an inverted triangle or trapezoid as is shown in FIG. 3. A shape similar to an inverted Christmas tree, such as is commonly used on the base of turbine blades, can also be used, either in a circumferential direction or with many such shapes cut in a direction parallel to an axis of rotation of the gear assembly 300. One or more ribs spanning between two separate points on the inner circumference of the ring gear 202 can also be used. Such ribs can optionally include pass-through holes to allow the liquid second material to flow through and inter-connect during casting. Undercut shapes of the one or more tensioning features 302 can be used such that that the ring gear 202 is gripped more strongly as it is placed under tension by the contracting second material as it cools. The shape of a cross-section of the ring gear 202 can be optimized such that the shape of the one or more tensioning features 302 and the resulting stress concentrations are optimized under various stress conditions experienced by a gear assembly 300. The ring gear 202 can advantageously be thin enough for the forces generated by the differential expansion to cause it to be compressed or stretched. However, the shape of the one or more tensioning features 302 can tend to concentrate this stretching to thinner sections of the ring gear 202, for example those sections between the teeth 206 of the ring gear 202. The profile of the ring gear 202 can be adjusted as a function of position and proximity to one of the one or more tensioning features 302 to minimize this effect. While configuring a gear assembly 300 such that the ring gear 202 is under compression at low temperatures, which lessen as the gear assembly 300 is heated, can minimize the life impacts for the expansive stresses. However, in some implementations of the current subject matter, the profile of the teeth 206 on the ring gear 202 can be held accurately even under this compression and stretching through use of a varying cross section of the ring gear 202 depending on whether a tooth 206 or area between teeth 206 (e.g a “root”) is present. Final tooth shape formation can also be performed at an anticipated operating temperature to lessen these effects.

In other implementations of the current subject matter, the second material used for the gear core 204 need not be limited to aluminum or to any particular alloy or material with any particular thermal expansion properties. For example, the second material can optionally have either a higher or a lower coefficient of thermal expansion than the first material used for the ring gear 202. Examples of second materials can include, without limitation, silicon, aluminum, magnesium, brass, or the like. A choice of the second material, which can differ from the material used in the engine block 106 of an engine, can be made to compensate for thermal expansion, for example if the operating temperature of a gear train differs from that of the bulk of the engine block.

A second material can be chosen for the gear core 204 of a gear assembly 300 to allow better thermal expansion matching, even with different operating temperatures. For example, the first material from which the gear core 204 is constructed can have a first coefficient of thermal expansion that is either a) approximately equal to a gear train support coefficient of thermal expansion of the support structure or b) at least approximately proportional to the gear train support coefficient of thermal expansion according to a ratio of a first operation temperature of the gear assembly divided by a second operation temperature of the gear train support structure. In other words, the gear core 204 and the support structure can have differing coefficients of thermal expansion to account for different expected operating temperatures of the support structure and the gear train. For example, a gear core 204 can have a larger (or smaller) first coefficient of thermal expansion than the gear train support thermal expansion coefficient of the support structure (e.g. an engine block) to account for an expected larger operating temperature of the support structure and the gear assembly. In another option, the first coefficient of thermal expansion can be smaller than the gear train support thermal expansion coefficient to account for an expected smaller operating temperature of the gear train than the support structure. Assuming that the coefficients of thermal expansion are approximately constant over the range of temperatures experienced by the gear train and support structure, a ratio of the first coefficient of thermal expansion to the gear train support thermal expansion coefficient can be approximately equal to a ratio of the expected operating temperature of the gear assembly to the expected operating temperature of the support structure.

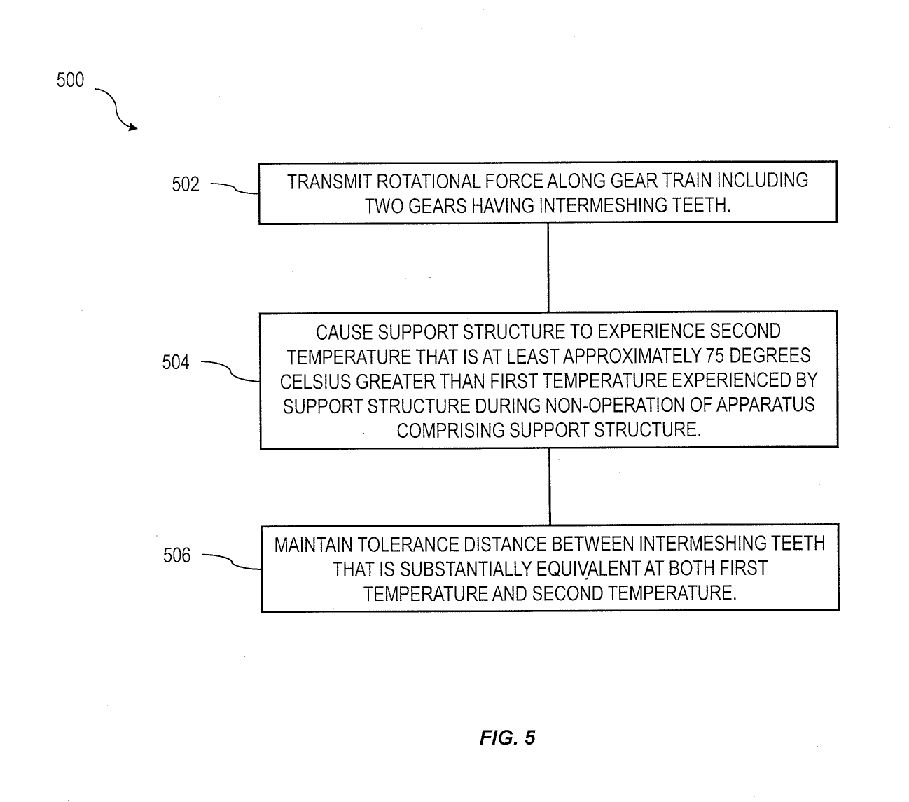

FIG. 5 shows a first process flow chart illustrating features of a method consistent with implementations of the current subject matter. At 502, rotational forces are transmitted along a gear train, which can include two gears mounted on rotating shafts that are secured at a relative separation distance by a support structure. The two gears can have intermeshing gear teeth. At 504, the support structure can experience a second temperature that is at least approximately 75° C. (or optionally in a range of approximately 60° C. to approximately 160° C.) greater than a first temperature experienced by the support structure (i.e., engine block), such as during non-operation of an apparatus (i.e., internal combustion engine) comprising the support structure. In some examples, the second temperature can be at least approximately 125° C. greater than the first temperature. At 506, the tolerance distance between the intermeshing gear teeth of the two gears can be maintained, including under first temperature and second temperature conditions.

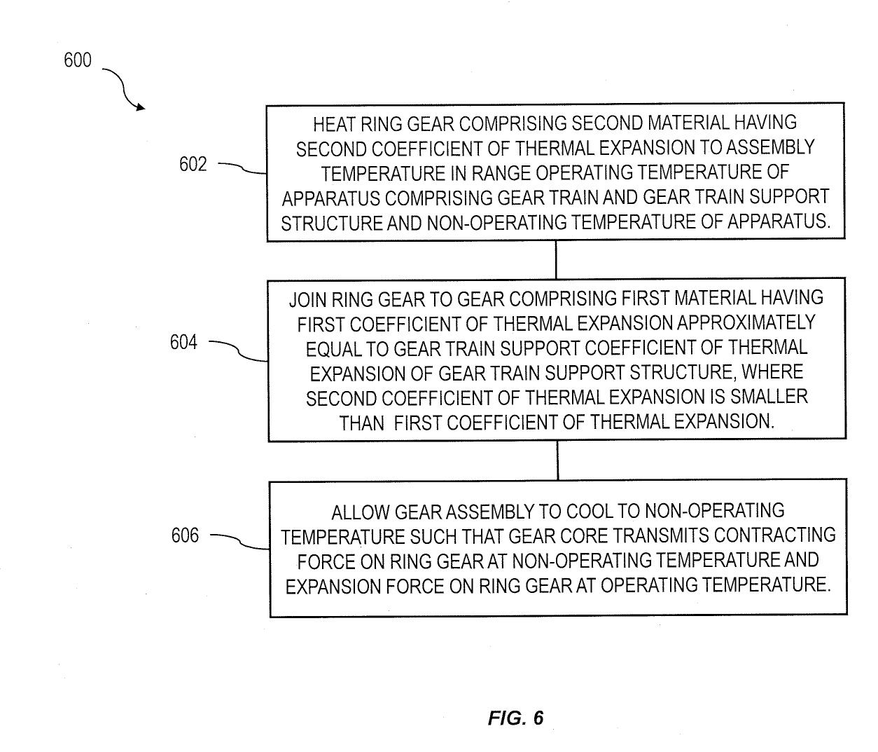

FIG. 6 shows a first process flow chart illustrating features of a method for assembling a gear assembly consistent with implementations of the current subject matter. At 602, a ring gear is heated to at least an assembly temperature. The assembly temperature can be in a range of approximately 35% to 75% of a difference between an operating temperature of an apparatus comprising the gear train and the gear train support structure and a non-operating temperature of the apparatus. For example, where the apparatus is an engine, the engine operating temperature can be approximately 125° C. to 150° C. and the engine non-operating temperature can be approximately 25° C., or optionally as low as −40° C. The assembly temperature can optionally be in a range of 40° C. to 100° C. The assembly temperature can optionally be chosen based on one or more of the thermal expansion coefficients of the first and second materials, desired stress levels (e.g. expansion and contraction) for the completed gear assembly, an amount of interference used for a press fit assembly procedure, etc. In an example, the assembly temperature can be approximately 75° C.

At 604, the ring gear is joined to a gear core such that the ring gear is disposed along a perimeter of the gear core to form the gear assembly. As with other gear assembly features described herein, the gear core can include a first material having a first coefficient of thermal expansion, and the first coefficient of thermal expansion can be approximately equal to a gear train support coefficient of thermal expansion of the gear train support structure. The ring gear can include a second material having a second coefficient of thermal expansion that is smaller than the first coefficient of thermal expansion. The joining can include pressing the ring gear over the ring core, casting the gear core by providing the second material in a molten form inside of the ring gear, or the like.

At 606, for a casting approach, the gear assembly can optionally be allowed to cool to the non-operating temperature such that the gear core transmits a contracting force on the ring gear at the non-operating temperature and an expansion force on the ring gear at the operating temperature. As discussed above, in some implementations of the current subject matter, at least the contracting force can be transmitted from the gear core to the ring gear at least in part via a tensioning feature on the ring gear that is interlocked with a mating feature on the gear core.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A gear assembly comprising:
a gear core comprising a first material having a first coefficient of thermal expansion, the first coefficient of thermal expansion being either a) approximately equal to a gear train support coefficient of thermal expansion of a gear train support structure onto which the gear assembly is configured to be mounted or b) at least approximately proportional to the gear train support coefficient of thermal expansion according to a ratio of a first operation temperature of the gear assembly divided by a second operation temperature of the gear train support structure;
a ring gear disposed along a perimeter of the gear core, the ring gear comprising a second material having a second coefficient of thermal expansion, the second coefficient of thermal expansion being smaller than the first coefficient of thermal expansion.

2. The gear assembly of 1, wherein the gear train support structure comprises an engine block of an internal combustion engine.

3. The gear assembly of claim 1, wherein the first material comprises one or more of aluminum, magnesium, brass, silicone or plastic.

4. The gear assembly of claim 1, wherein the second material comprises steel.

5. The gear assembly of claim 1, wherein the ring gear comprises tooth features disposed along an outer periphery of the ring gear for meshing with one or more other gears or gear assemblies.

6. The gear assembly of claim 1, further including a hub comprising the second material.

7. The gear assembly of claim 1, wherein a ratio of the first coefficient of thermal expansion to the second coefficient of thermal expansion is within a range of approximately 1.5 to 2.

8. The gear assembly of claim 1, wherein the first coefficient of thermal expansion is within a range of approximately 20×10⁻⁶ mm⁻¹·K⁻¹ to 25×10⁻⁶ m·m⁻¹·K⁻¹ at 25° C.

9. The gear assembly of claim 1, wherein the second coefficient of thermal expansion is within a range of approximately 10×10⁻⁶ m·m⁻¹·K⁻¹ to 15×10⁻⁶ m·m⁻¹·K⁻¹ at 25° C.

10. The gear assembly of claim 1, wherein the ring gear comprises a tensioning feature that interlocks with a mating feature of the gear core.

11. The gear assembly of claim 10, wherein the tensioning feature interlocked with the mating feature facilitates transmission of at least contraction forces exerted by the gear core to the ring gear.

12. The gear assembly of claim 10, wherein the tensioning feature has a triangular or trapezoidal shape, an apex of the triangular or trapezoidal shape that is narrower than a base of the triangular or trapezoidal shape being directed away from a center axis of the gear core.

13. A method comprising:
transmitting rotational force along a gear train comprising two gears mounted on rotating shafts secured at a relative separation distance by a support structure, the two gears comprising intermeshing gear teeth;
causing the support structure and gear train to experience second temperatures during operation of an apparatus comprising the support structure, the second temperature being at least approximately 75° C. greater than a first temperature experienced by the support structure during non-operation of the apparatus comprising the support structure;
maintaining a tolerance distance between the intermeshing gear teeth of the two gears that is substantially equivalent at both the first temperature and the second temperature.

14. The method of claim 13, wherein at least one gear of the two gears comprises a gear assembly, the gear assembly comprising a gear core and a ring gear, the gear core comprising a first material having a first coefficient of thermal expansion, the first coefficient of thermal expansion being a) approximately equal to a gear train support coefficient of thermal expansion of the support structure or b) at least approximately proportional to the gear train support coefficient of thermal expansion according to a ratio of a first operation temperature of the gear assembly divided by a second operation temperature of the gear train support structure, the ring gear being disposed along a perimeter of the gear core and comprising a second material having a second coefficient of thermal expansion that is smaller than the first coefficient of thermal expansion.

15. The method of claim 13, wherein the support structure comprises an engine block of an internal combustion engine.

16. The method of claim 13, further comprising transmitting expansion and contraction forces exerted by the gear core to the ring gear, the transmitting of at least the contraction forces occurring at least in part via a tensioning feature of the ring gear that is interlocked with a mating feature of the gear core.

17. A method for assembling a gear assembly for use as part of a gear train, the gear train comprising two gears mounted on rotating shafts secured at a relative separation distance by a gear train support structure, the two gears comprising intermeshing gear teeth, the method comprising:
heating a ring gear to at least an assembly temperature in a range between an operating temperature of an apparatus comprising the gear train and the gear train support structure and a non-operating temperature of the apparatus; and
joining the ring gear to a gear core such that the ring gear is disposed along a perimeter of the gear core to form the gear assembly, the gear core comprising a first material having a first coefficient of thermal expansion, the first coefficient of thermal expansion being approximately equal to a gear train support coefficient of thermal expansion of the gear train support structure, the ring gear comprising a second material having a second coefficient of thermal expansion, the second coefficient of thermal expansion being smaller than the first coefficient of thermal expansion.

18. The method of claim 17, wherein the assembly temperature range comprises approximately 40° C. to 100° C.

19. The method of claim 17, wherein the joining comprises at least one of pressing the ring gear over the ring core and casting the gear core by providing the second material in a molten form inside of the ring gear.

20. The method of claim 17, further comprising allowing the gear assembly to cool to the non-operating temperature such that the gear core transmits a contracting force on the ring gear at the non-operating temperature and an expansion force on the ring gear at the operating temperature.

21. The method of claim 20, wherein at least the contracting force is transmitted from the gear core to the ring gear at least in part via a tensioning feature on the ring gear that is interlocked with a mating feature on the gear core.
